(19) United States
(12) Patent Application Publication
(10) Pub. No.: US 2023/0271226 A1
(43) Pub. Date: Aug. 31, 2023

(54) DROSS EXTRACTION IMPLEMENT FOR AN MHD PRINTER AND METHODS THEREOF

(71) Applicant: XEROX CORPORATION, NORWALK, CT (US)

(72) Inventors: Joseph C. SHEFLIN, Macedon, NY (US); Gary D. REDDING, Dansville, NY (US); Joshua S. HILTON, Rochester, NY (US); Peter M. GULVIN, Webster, NY (US)

(73) Assignee: XEROX CORPORATION, NORWALK, CT (US)

(21) Appl. No.: 17/652,532

(22) Filed: Feb. 25, 2022

(51) Int. Cl. B08B 1/00; B33Y 30/00; B33Y 40/00; B22F 12/00; B08B 1/04

(52) U.S. Cl. CPC B08B 1/001; B33Y 30/00; B33Y 40/00; B22F 12/00; B08B 1/04; B33Y 10/00

(57) ABSTRACT

A dross extraction implement for a printer is described. The dross extraction implement includes a cylindrical portion having a first section along a length of the cylindrical portion of the extraction implement having a first diameter and a second section along a length of the cylindrical portion of the extraction implement having a second diameter, where the first section is adjacent to the second section. The dross extraction implement is configured to be advanced into and retracted from an inner cavity of an ejector in the printer. A printer using the dross extraction implement and a method of using is also described.

### TECHNICAL FIELD

The present teachings relate generally to liquid ejectors in drop-on-demand (DOD) printing and, more particularly, to a dross extraction system and methods for use within a DOD printer.

### BACKGROUND

A drop-on-demand (DOD) or three-dimensional (3D) printer builds (e.g., prints) a 3D object from a computer-aided design (CAD) model, usually by successively depositing material layer upon layer. A drop drop-on-demand (DOD), particularly one that prints a metal or metal alloy, ejects a small drop of liquid aluminum alloy when a firing pulse is applied. Using this technology, a 3D part can be created from aluminum or another alloy by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer to form a 3D metallic object. Magnetohydrodynamic refers to the study of the magnetic properties and the behavior of electrically conducting fluids.

In MHD printing, a liquid metal is jetted out through a nozzle of the 3D printer onto a substrate or onto a previously deposited layer of metal. A printhead used in such a printer is a single-nozzle head and includes several internal components within the head which may need periodic replacement. In some instances, a typical period for nozzle replacement may be an 8-hour interval. During the liquid metal printing process, the aluminum and alloys, and in particular, magnesium containing alloys, can form oxides and silicates during the melting process in the interior of the pump. These oxides and silicates are commonly referred to as dross. The buildup of dross is a function of pump throughput and builds continuously during the print process. In addition to being composed of a combination of aluminum and magnesium oxides and silicates, the dross may also include gas bubbles. Consequently, the density of the dross may be lower than that of the liquid metal printing material and builds at the top of the melt pool, eventually causing issues during printing. In addition, dross accumulation impacts the ability of internal level-sensing that measures the molten metal level of the pump. This can cause the pump to erroneously empty during printing, thereby ruining the part. Dross plugs may also grow within the pump causing issues with the pump dynamics resulting in poor jet quality and additional print defects, such as the formation of satellite drops during printing. The dross could potentially break apart and a chunk of this oxide falls into the nozzle resulting in a clogged nozzle. All of the aforementioned failures arising from dross accumulation are catastrophic, leading to printer shut down, requiring clearing or removal of the dross plug, replacing the print nozzle, and beginning start-up procedures again.

Thus, a method of and apparatus for removal or extraction of dross in a metal jet printing drop-on-demand or 3D printer is needed to provide longer printing times and higher throughput without interruption from defects or disadvantages associated with dross build-up.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A dross extraction implement for a printer is described. The dross extraction implement also includes a cylindrical portion. The dross extraction implement also includes a first section along a length of the cylindrical portion of the extraction implement having a first diameter. The dross extraction implement also includes a second section along a length of the cylindrical portion of the extraction implement having a second diameter, where the first section is adjacent to the second section. The dross extraction implement is configured to be advanced into and retracted from an inner cavity of an ejector in the printer.

Implementations of the dross extraction implement may include where the second section is adjacent to an end of the cylindrical portion of the extraction implement, and the first diameter is greater than the second diameter. Alternately, the second diameter is greater than the first diameter. The first section of the extraction implement further may include one or more radial protrusions, where each of the one or more radial protrusions may include a proximal portion and a distal portion, where the distal portion protrudes further from a center of the cylindrical portion of the extraction implement as compared to the proximal portion. The first section of the extraction implement further may include a protrusion that extends from the cylindrical portion at an angle that is less than 90 degrees relative to a longitudinal axis of the cylindrical portion of the extraction implement. The first section of the extraction implement further may include a protrusion that extends from the cylindrical portion at an angle that is less than 90 degrees relative to an axis that is perpendicular to a longitudinal axis of the cylindrical portion of the extraction implement. The first section of the extraction implement further may include a protrusion that extends from the cylindrical portion at an angle that is less than 90 degrees relative to a longitudinal axis of the cylindrical portion of the extraction implement, and where the first section of the extraction implement further may include a protrusion that extends from the cylindrical portion at an angle that is less than 90 degrees relative to an axis that is perpendicular to a longitudinal axis of the cylindrical portion of the extraction implement. The extraction implement may further include a ceramic material. The extraction implement is thermally stable at a temperature above 1000°. The extraction implement is inert in contact with a liquid printing material in the inner cavity of the ejector. The extraction implement may include tungsten carbide.

A printer is also disclosed. The printer includes an ejector defining an inner cavity associated therewith, where the inner cavity retains a liquid printing material. The printer also includes a first inlet coupled to the inner cavity. The printer also includes a dross extraction implement external to the ejector, which may include a cylindrical portion, a first section along a length of the cylindrical portion of the extraction implement having a first diameter, and a second section along a length of the cylindrical portion of the extraction implement having a second diameter, where the first section is adjacent to the second section, and the extraction implement is configured to be advanced into and retracted from the inner cavity of the ejector.

Implementations of the printer may include where the second section is adjacent to an end of the cylindrical portion of the extraction implement; the first diameter is greater than the second diameter, and the second diameter is greater than the first diameter. The first section of the extraction implement further may include one or more radial protrusions, where each of the one or more radial protrusions may include a proximal portion and a distal portion, where the distal portion protrudes further from a center of the cylindrical portion of the extraction implement as compared to the proximal portion. The first section of the extraction implement further may include a protrusion that extends from the cylindrical portion at an angle that is less than 90 degrees relative to a longitudinal axis of the cylindrical portion of the extraction implement, and where the first section of the extraction implement further may include a protrusion that extends from the cylindrical portion at an angle that is less than 90 degrees relative to an axis that is perpendicular to a longitudinal axis of the cylindrical portion of the extraction implement.

A method of extracting dross from a metal jetting printer is disclosed. The method of extracting dross includes operating the metal jetting printer while heating a nozzle pump reservoir in the metal jetting printer at a first temperature. The method of extracting dross also includes pausing an operation of the metal jetting printer. The method of extracting dross also includes advancing a dross extraction implement may include a cylindrical portion, a first section along a length of the cylindrical portion of the extraction implement having a first diameter, the extraction implement also including a second section along a length of the cylindrical portion of the extraction implement having a second diameter into a melt pool within the nozzle pump reservoir in the metal jetting printer, where the melt pool may include a metal printing material. The method also includes heating the nozzle pump reservoir in the metal jetting printer at a second temperature, extracting dross from a surface of the metal printing material and onto the extraction implement. The method further includes retracting the extraction implement including the dross from the nozzle pump reservoir, and resuming the operation of the metal jetting printer.

The method of extracting dross from a metal jetting printer may include rotating the dross extraction implement while extracting dross from a surface of the metal printing material and onto the extraction implement and while retracting the extraction implement including the dross from the nozzle pump reservoir. The first temperature employed in the method may be greater than the second temperature. The first temperature is 825 degrees C. and the second temperature is 650 degrees C.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid ejector jet of a 3D printer (e.g., a MHD printer and/or multi-jet printer), in accordance with the present disclosure.

FIG. 2 is a side cross-sectional views of a liquid ejector jet contaminated with dross, in accordance with the present disclosure.

FIGS. 3A-3H and 3J are a series of schematic views of several examples of dross extraction devices, in accordance with the present disclosure. Please note that FIG. 3I was skipped to avoid confusion with numeral 31.

FIGS. 4A-4F are a series of side cross-sectional views of a single liquid ejector jet, illustrating operative steps of using the dross extraction implement, in accordance with the present disclosure.

FIG. 5 is a flowchart illustrating a method of extracting dross in a metal jetting printer, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

In drop-on-demand (DOD), metal-jetting printing, or three-dimensional (3D) printing, a small drop of liquid aluminum or other metal or metal alloy are ejected when a firing pulse is applied. Using this printing technology, a 3D part can be created from aluminum, aluminum alloy, or another alloy by ejecting a series of drops which bond together to form a continuous part. During a typical printing operation, the raw printing material wire feed can be replenished to the pump inside an ejector using a continuous roll of aluminum wire. The wire printing material may be fed into the pump using standard welding wire feed equipment or other means of introduction, such as a powder feed system. As printing occurs and new material is fed into the pump, a contaminant known as dross may accumulate in the top of the upper pump of the ejector. This build-up of dross is a function of the total throughput of printing material through the pump and ejector. As the dross contamination builds within the pump and/or ejector it eventually results in defects such as degraded jetting performance, nozzle or machine contamination, level sensor faults, additional printer maintenance, shut down, or contamination related catastrophic failure. While systems exist to counteract dross accumulation in similar ejector and printer systems, they are fairly complex and require manual operations involving multiple operators.

The present disclosure provides the use of an extraction implement, device, or probe for removal of the dross directly from the upper pump. The extraction implement or instrument removal of the dross from the pump can be performed in-situ during a part build as long as the printing process is paused. A wire feed and level sensing operation may be paused manually or by the machine to address a dross contamination. The extraction implement is lowered into the dross residing on the top of the melt pool through a top opening in the upper print block. The implement is lowered into the dross while the melt pool is at nominal temperature of 825 degrees C. While the implement or probe is in the dross/melt pool the temperature of the pump is lowered to 650 degrees C. Once the pump has cooled the implement can be removed with the dross attached. At this point the pump can be reheated to 825 degrees C., wire feed and level sense may be enabled, and printing can resume. An exemplary dross extraction implement may include a cylindrical portion, a first section along a length of the cylindrical portion of the extraction implement having a first diameter, and a second section along a length of the cylindrical portion of the extraction implement having a second diameter. The first section may be adjacent to the second section and the extraction implement is configured to be advanced into and retracted from an inner cavity of an ejector in the printer. Dross extraction implement materials may include, but are not limited to, materials such as aluminum, stainless steel, titanium, tungsten carbide, surface treated ceramics, boron, alumina, aluminum nitride, zirconia, and the like. While references to the descriptive term “cylindrical” or “diameter” imply a common cylindrical form, i.e., one having a cross-section including a perfect circle, the implement segments described as cylindrical may also be understood to include a partially cylindrical cross-section which is not explicitly circular. This may include a cross-section of a cylindrical portion having flat sides, square, triangular, or even rectangular cross-section as forming a portion of the implement. Furthermore, “cylindrical” may include any shape or cross-section, and “diameter” may include any significant dimension of the cross-section in a location along the implement.

In embodiments described herein, the extraction implement is lowered into the dross floating at the top of the molten aluminum melt pool in the jetting crucible or pump in a printing system having a metal jetting liquid ejector. One or more physical structural features of a tip of, or alternatively, the material of the extraction implement itself enables the aluminum and dross to wet and adhere to the surface of the extraction implement as it is lowered into and withdrawn from the crucible. A lowering of the temperature of the crucible, or inner cavity of the ejector, may facilitate the removal of the dross. In certain examples, the extraction implement may be cleaned and re-used. The extraction implement may be inserted and withdrawn or retracted manually, or in an automated, mechanical fashion. The material of the extraction implement would not interfere with the electrical pulses used to jet the aluminum, so it may optionally be used during the jetting cycle, and without disrupting a printing operation.

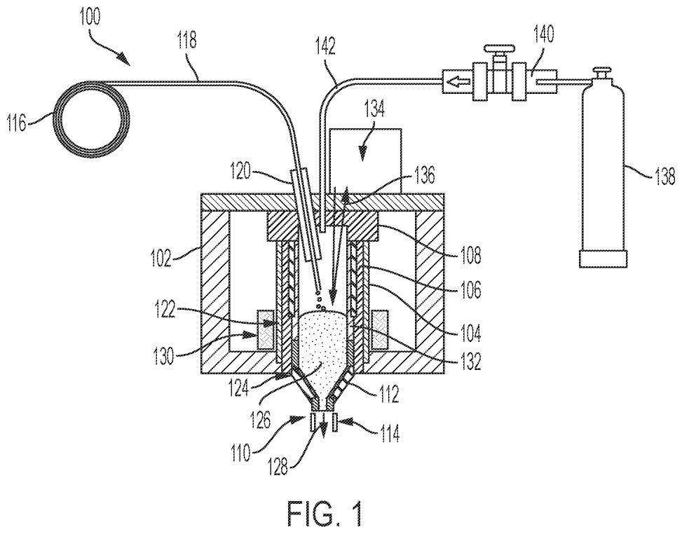

FIG. 1 depicts a schematic cross-sectional view of a single liquid ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity). A printing material 126 may be introduced into the inner volume 132 of the ejector 104. The printing material 126 may be or include a metal, a polymer, or the like. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, also referred to as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate, not shown herein, that is positioned proximate to (e.g., below) the nozzle 110. The ejected drops 128 may land on the substrate and solidify to produce a 3D object. The 3D printer 100 may also include a substrate control motor that is configured to move the substrate while the drops 128 are being jetted through the nozzle 110, or during pauses between when the drops 128 are being jetted through the nozzle 110, to cause the 3D object to have the desired shape and size. The substrate control motor may be configured to move the substrate in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate may be moved under a stationary nozzle 110, or the nozzle 110 may be moved above a stationary substrate. In yet another example, there may be relative rotation between the nozzle 110 and the substrate around one or two additional axes, such that there is four or five axis position control. In certain examples, both the nozzle 110 and the substrate may move. For example, the substrate may move in X and Y directions, while the nozzle 110 moves up and/or down in a Y direction.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate, additional system elements, or a combination thereof may be positioned at least partially within the enclosure 102. In another example, the ejector 104, the heating elements 112, the power source, the coils, the substrate, additional system elements, or a combination thereof may be positioned at least partially outside of the enclosure 102.

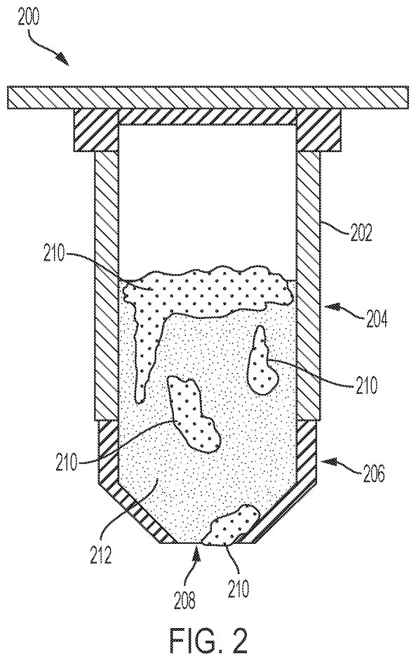

FIG. 2 is a side cross-sectional views of a liquid ejector jet contaminated with dross, in accordance with the present disclosure. The ejector 200 is shown, which further defines a cavity or outer wall 202 of the ejector, an upper pump area 204, a lower pump area 206, and an outlet nozzle 208. Within the inner cavity 202 of the ejector 200 is further shown a molten printing material 212 and schematic of dross 210 build-up within and on top of the printing material 212. The dross 210, in certain examples, and dependent upon which printing material is used in the printing system, is a combination of aluminum oxides, magnesium oxides, and silicates. The dross 210 may also include gas bubbles. In certain examples, the dross 210, may include additional materials or contaminants, such as oxides and silicates of aluminum (Al), calcium (Ca), magnesium (Mg), silicon (Si), iron (Fe), or possibly other contaminants containing sodium (Na), potassium (K), sulfur (S), chlorine (Cl), carbon (C) or combinations thereof, The dross 210 typically builds towards the top of the melt pool that resides near the upper pump area 204 in the ejector 200 and may potentially cause issues during printing. Dross 210 accumulation may potentially impact the ability of the aforementioned level sensor that measures the molten metal level inside the ejector 200. An erroneous signal for the level sensor system can cause the pump to empty during printing, which could result in ruining the part being printed. One or more dross 210 “plugs” may also have a propensity to grow within the pump, which in turn may cause issues with the pump dynamics. Interruptions or issues in pump dynamics may further result in poor jet quality and the formation of satellite drops during printing. A satellite drop may refer to a drop with only a fraction of the volume of the main drop which can be unintentionally formed during the jetting of a main drop. For example, a physical occlusion at the nozzle is one potential cause resulting in the formation of a satellite drop. In certain examples or instances, the dross 210 could also potentially break apart, and a portion of this fragmented dross or oxide may fall into the nozzle 208 resulting in a clogged nozzle 208. Any failure arising from the accumulation of dross 210 has the tendency to be catastrophic, which could lead to necessitating a shut down of the printer, having to clear or remove the dross 210 plug, replacing the print nozzle, beginning start-up again, or combinations thereof.

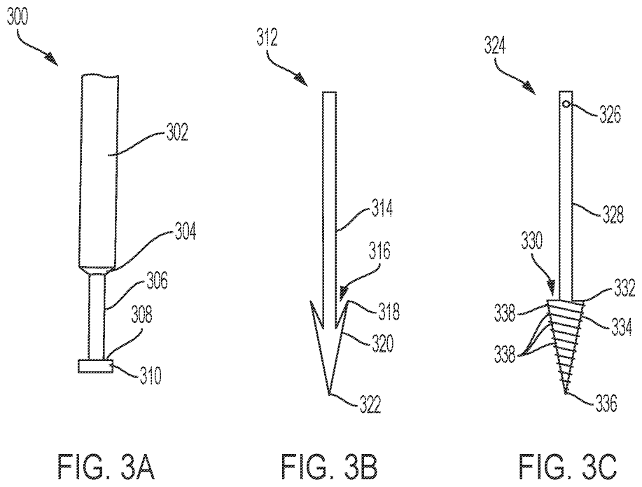

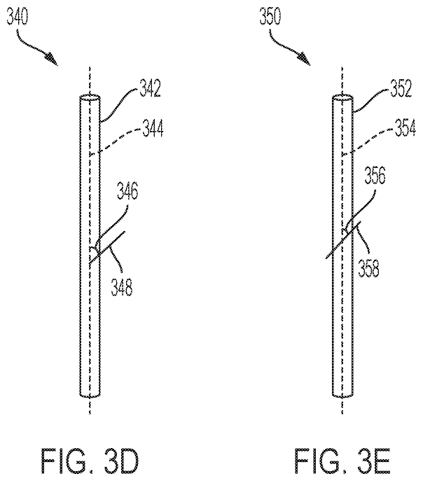

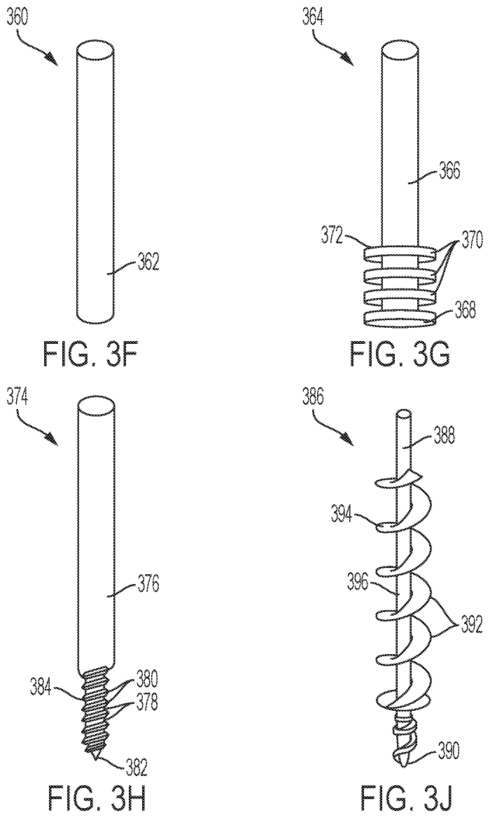

FIGS. 3A-3H and 3J are a series of schematic views of several examples of dross extraction devices, in accordance with the present disclosure. FIG. 3A depicts a portion of a dross extraction implement 300 defining a cylindrical portion 302 or shaft. In the exemplary example shown, the cylindrical portion 302 further defines a gradient 304, which transitions from the cylindrical portion 302 to a second section 306 having a second diameter. Adjacent to the second section is a first section 310 having a first diameter. A step or shelf 308 of approximately 90-degree angle with respect to the cylindrical portion 302 defines a transition between the first section 310 and the second section 306. The dross extraction implement 300 shown in FIG. 3A may be used to extract dross by utilizing the physical configuration and arrangement of the shelf 308 between the first section 310 and the second section 306 to catch, snare, or sequester dross contamination from a surface of a melt pool within an MHD printer. Such a shaped arrangement may provide an upward facing shelf, upon which a sample of dross may be retained for expedient removal. The upward-facing surface is capable of supporting dross as the extraction implement is retracted from the inner cavity of the ejector in the printer. In some examples, the first diameter may be larger than the second diameter, and in other examples, the second diameter may be larger than the first diameter.

FIG. 3B depicts a dross extraction implement 312 defining a cylindrical portion 314 or shaft. The cylindrical portion 314 further defines an angled section 316 which forms an acute angle between the cylindrical portion 314 and a second section 320 having a second diameter 318. The second diameter 318 defines the angled section 316 having an angle of less than 90-degrees with respect to the cylindrical portion 314 of the dross extraction implement 312. A first section 322 adjacent to the second section 320 defines and forms a point at an end of the dross extraction implement 312 in this example. Again, this angled, harpoon-shaped physical configuration as shown may be advantageous in catching, snaring, or sequestering dross contamination from a surface of a melt pool within an MHD printer.

FIG. 3C depicts another exemplary example of a dross extraction implement 324 defining a cylindrical portion 328. The cylindrical portion 328 further defines a hole 326, which may also be considered a recess, hook, or other means to hold or suspend one or more of the examples of dross extraction implements or devices described herein at a convenient location on or near a 3D printer in which the dross extraction implement 324 might be used. A step or shelf 330 is defined by the cylindrical portion 328 at a 90-degree angle with respect to the cylindrical portion 328 of the dross extraction implement 324. The step or shelf 330 also forms a transition between the cylindrical portion 328 and a first section 334 having a first diameter 332. The first section further transitions towards an adjacent second section 336, which terminates in a pointed shape or acute angle at an end of the dross extraction implement 324. The first section 334 also defines one or more ridges or protrusions 338 which may be a single spiraling individual protrusion, which spirals around a diameter of the dross extraction implement 324 from the first section 334 towards the second section 336, which may angled with respect to a perpendicular direction relative to the cylindrical portion 328 or shaft of the dross extraction implement 324. Alternatively, the one or more protrusions 338 may be individual as depicted and in alternate examples may be at an angle perpendicular with respect to the cylindrical portion 328 or shaft of the dross extraction implement 324. The one or more protrusions 338 may be serrated or segmented, the segments having rectangular shapes, rounded shapes, triangular shapes, or combinations thereof in certain examples. In other examples, the first diameter is larger than the second diameter, and in other examples, the second diameter is larger than the first diameter. The one or more protrusions 338 may form and define a third diameter with respect to the first or second diameters of the first section 334 or the second section 336, respectively. It should be noted that the this angled, pointed, honeycomb-shaped physical configuration as shown may be advantageous in catching, snaring, or sequestering dross contamination from a surface of a melt pool within an MHD printer.

FIG. 3D depicts an exemplary portion of a dross extraction implement 340 having a shaft or cylindrical portion 342 which defines a longitudinal axis 344 of the cylindrical portion 342. A protrusion 348 forming a first plane having an angle 346 less than 90-degrees relative to the longitudinal axis 344 of the cylindrical portion 342 is shown, showing a general configuration of a single protrusion or a plurality of protrusions as may be applied to any of the exemplary dross extraction implements described herein. FIG. 3E depicts an exemplary portion of a dross extraction implement 350 having shaft or cylindrical portion 352 which defines alongitudinal axis 354 of the cylindrical portion 352. A protrusion 358 forming a second plane facing away from the page having an angle 356 less than 90-degrees relative to the longitudinal axis 354 of the cylindrical portion 352 is shown, showing a general configuration of a single protrusion or a plurality of protrusions as may be applied to any of the exemplary dross extraction implements described herein. While an approximate angle of 45-degrees is shown in both FIGS. 3D and 3E, the angle of a protrusion 348, 358 may be between an angle of from about 10 to about 90 degrees in other examples. Any elements of the various dross extraction implements would necessarily be inert in contact with the liquid printing material, temperature resistant, and may include one or more textured external surfaces, useful for physically attracting dross to thereto. External protrusions or externally radiating features may serve to maximize surface area along the cylindrical portion of one of the dross extraction implements. The dross extraction implements described herein may also cover an auger shape, a screw threaded shape, or similar shapes. Any of the dross extraction implements as described herein may be made from a number of materials that are temperature resistant to up to 1000° C. and above, thermally conductive, and inert when in contact with printing materials used in exemplary MHD printers. Thermally conductive materials may serve to locally lower the temperature of the dross a dross extraction implement may be contact with. The dross extraction implement may be made from a number of metals, such as aluminum, stainless steel, titanium, tungsten carbide, or combinations thereof. A number of coatings or surface treatments may also be used on a portion of or on the entire dross extraction implement in order to enhance either temperature resistance, inertness in contact with printing materials, improved wetting and contact with printing materials, or a combination thereof. Such external coatings may include ceramics such as aluminum nitride, zirconia, tungsten carbide, alumina, boron, or ceramic-coated aluminum, as well as surface treatments such as anodization, ion implantation, coatings, and the like. It should further be noted that any of the above examples, features, elements, or arrangements may be combined within a single dross extraction device or implement to provide improved efficiency or effectiveness at dross removal from an MHD printer. An inert or cooling gas source may also be used in conjunction with the dross extraction implement to enable cooling of the localized area around the dross such that the contamination may further solidify and thus be easier to extract. Some examples of exemplary dross extraction implements may include the use of a cooling element disposed external to or integrated within a dross extraction implement, which may be gas-cooled, fluid-cooled, or refrigerant-cooled. Certain aspects of a dross extraction implement as described herein may include a one-time use implement, while other aspects may include a reusable or cleanable dross extraction implement.

Any of the dross extraction implements for a metal jetting printer as described herein may include a cylindrical portion, a first section along a length of the cylindrical portion of the extraction implement having a first diameter, and a second section along a length of the cylindrical portion of the extraction implement having a second diameter, wherein the first section is adjacent to the second section, and the extraction implement is configured to be advanced into and retracted from an inner cavity of an ejector in the printer. In some aspects, the second section is adjacent to an end of the cylindrical portion of the dross extraction implement. In exemplary examples, the first section of the dross extraction implement includes one or more radial protrusions, with each of the one or more radial protrusions having a proximal portion and a distal portion, the distal portion protruding further from a center of the cylindrical portion of the dross extraction implement as compared to the proximal portion. In some examples, the first section of the dross extraction implement includes a protrusion that extends from the cylindrical portion at an angle that is less than 90 degrees relative to a longitudinal axis of the cylindrical portion of the extraction implement. In certain examples, the first section of the dross extraction implement includes a protrusion that extends from the cylindrical portion at an angle that is less than 90 degrees relative to an axis that is perpendicular to a longitudinal axis of the cylindrical portion of the extraction implement. Some examples of dross extraction implements may include a first section of the extraction implement having a protrusion that extends from the cylindrical portion at an angle that is less than 90 degrees relative to a longitudinal axis of the cylindrical portion of the extraction implement, and also where the first section of the extraction implement further includes a protrusion that extends from the cylindrical portion at an angle that is less than 90 degrees relative to an axis that is perpendicular to a longitudinal axis of the cylindrical portion of the extraction implement. Additional materials that are suitable for such high temperature applications such as those described herein include materials that are thermally stable at temperatures from about 850° C. to about 1600° C., are chemically, magnetically, and physically inert in contact with printing materials or within the printing system. Suitable probe materials include graphite, boron, aluminum, boron nitride, aluminum oxide, aluminum nitride, zirconium oxide, or combinations thereof. Some probes may be surface treated by plasma treatment, corona treatment, surface coating, texturing, machining, or combinations thereof. The probe may be a 3-6 mm diameter probe, or alternatively, larger or smaller sized probes may be chosen for used based on a proportional size to the ejector size or the system throughput.

FIG. 3F depicts an exemplary portion of a dross extraction implement 360 having a shaft or cylindrical portion 362. The dross extraction implement 360 shown in FIG. 3F may be referred to as a rod-shaped dross extraction implement. The rod-shaped dross extraction implement 360 may be solid in certain examples, or alternatively hollow in one or more sections along a length of the cylindrical portion 362 of the dross extraction implement 360. Exemplary examples of the dross extraction implement 360 may not be round and may have a shaft or length that is not circular in cross-section, but may be rectangular, square, triangular, grooved along the length, or a combination thereof.

FIG. 3G depicts an exemplary portion of a dross extraction implement 364 having a shaft or cylindrical portion 366. The dross extraction implement 364 shown in FIG. 3G may be referred to as a honey-dipper type of dross extraction implement. The dross extraction implement 364 may define one or more protrusions 370 interspersed along a length of one or more portions of the cylindrical portion 366 and extending therefrom. As shown, the section disposed towards an end 368 of the cylindrical portion 366 of the extraction implement 364, includes at least one upward-facing surface 372. Each protrusion 370 defines an upward facing surface 372. The upward-facing surface 372 is capable of supporting dross as the dross extraction implement is retracted from an inner cavity of an ejector in the metal jetting printer. While the protrusions 370 are equally spaced and interspersed with grooves having the same diameter or thickness as the cylindrical portion 366, exemplary examples of the dross extraction implement 364 may not have round or circular protrusions 370 or may have a shaft or length or cylindrical portion 366 that is not circular in cross-section, but may be rectangular, square, triangular, grooved along the length, or a combination thereof. The dross extraction implement 364 may have equally spaced protrusions 370 interspersed with grooves, or alternatively, the grooves or protrusions 370 may not be equally spaced. Certain examples may include protrusions 370 that are parallel to one another. In other examples, the protrusions 370 may not be parallel to one another. The protrusions 370 in certain examples may descend in circumference on each new protrusion 370 moving towards the end 368 of the dross extraction implement 364, while in other examples, the protrusions 370 ascend in circumference on each new protrusion 370 towards the end 368 of the dross extraction implement 364. Still other examples may have protrusions 370 having randomly occurring circumferences. The dross extraction implement 364 may have one or more protrusions 370 that are continuous around a circumference of the cylindrical portion 366, while alternative examples, may have staggered or non-continuous protrusions 370 around a circumference of the cylindrical portion 366.

FIG. 3H depicts an exemplary portion of a dross extraction implement 374 having a shaft or cylindrical portion 376 terminating in a screw-like portion. Towards an end 382 of the dross extraction implement 374, a section is defined having one or more threads 380 disposed around a circumference of the cylindrical portion 376. The cylindrical portion 376 and the threads 380 combine to further define a minor diameter 378 of the dross extraction implement 374. An outer surface of the one or more threads 380 define an upward-facing surface 384 which is capable of supporting dross as the dross extraction implement is retracted from an inner cavity of an ejector in the metal jetting printer. The threads 380 may also be referred to as protrusions and the inner cylindrical portion 376 may alternatively be referred to as the minor diameter 378, or first diameter. The outermost surface or crest of each thread 380 may be referred to as the major diameter. Either the major diameter or the minor diameter 378 may be greater than, equal to, or smaller than a diameter of the cylindrical portion 376 in certain examples. Alternatively, the dross extraction implement 374 may have a thread 380 angle describing an angle of a thread 380 relative to the cylinder 376 or shaft, which may be less than 90 degrees and facing towards the end 382 of the dross extraction implement 374, or less than 90 degrees and facing away from an end 382 of the dross extraction implement 374. Each thread 380 has a pitch or distance between each neighboring thread 380. In certain examples, the pitch may or may not be the same between each pair of neighboring threads 380, and alternatively may define different pitches between threads 380. This attribute may further influence an angle of the thread 380 relative to a longitudinal axis of the shaft or cylindrical portion 376. The dross extraction implement 374 may have one or more threads 380 that are continuous around a circumference of the cylindrical portion 376, while alternative examples, may have staggered or non-continuous threads 380 around a circumference of the cylindrical portion 376. In varying examples, threads 380 may be continuous or non-continuous. In other examples, threads 380 may ascend clockwise or counterclockwise from the end 382 of the dross extraction implement 374.

FIG. 3J depicts an exemplary portion of a dross extraction implement 386 having a shaft or cylindrical portion 388, terminating in an auger-like portion. Towards an end 390 of the dross extraction implement 386, a section is defined having one or more helical blades 392, also referred to as threads or flightings, disposed around a circumference of the cylindrical portion 388. The cylindrical portion 388 and the helical blades 392 combine to further define a minor diameter 396 of the dross extraction implement 386. An outer surface of the one or more helical blades 392 define an upward-facing surface 394 which is capable of supporting dross as the dross extraction implement is retracted from an inner cavity of an ejector in the metal jetting printer. The helical blades 392 may also be referred to as protrusions and the inner cylindrical portion 388 may alternatively be referred to as the minor diameter 396, or first diameter. The outermost surface or crest of each helical blade 392 may be referred to as the major diameter. Either the major diameter or the minor diameter 396 may be greater than, equal to, or smaller than a diameter of the cylindrical portion 388 in certain examples. Alternatively, the dross extraction implement 386 may have a helical blade 392 angle describing an angle of a helical blade 392 relative to the cylinder 388 or shaft, which may be less than 90 degrees and facing towards the end 390 of the dross extraction implement 386, or less than 90 degrees and facing away from an end 390 of the dross extraction implement 386. Each helical blade 392 has a pitch or distance between each neighboring helical blade 392. In certain examples, the pitch may or may not be the same between each pair of neighboring helical blade 392, and alternatively may define different pitches between helical blade 392. This attribute may further influence an angle of the helical blade 392 relative to a longitudinal axis of the shaft or cylindrical portion 388. The dross extraction implement 386 may have one or more helical blades 392 that are continuous around a circumference of the cylindrical portion 388, while alternative examples, may have staggered or non-continuous helical blades 392 around a circumference of the cylindrical portion 388. In varying examples, helical blades 392 may be continuous or non-continuous. In other examples, helical blades 392 may ascend clockwise or counterclockwise from the end 390 of the dross extraction implement 386. Any of the preceding described features or combinations thereof may be incorporated into a dross extraction implement in one or more instances of an exemplary dross extraction implement.

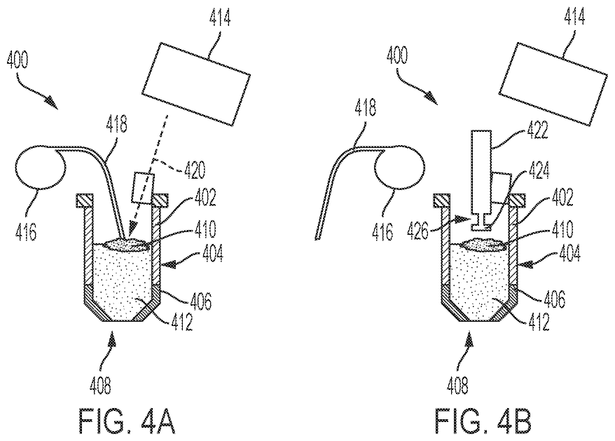

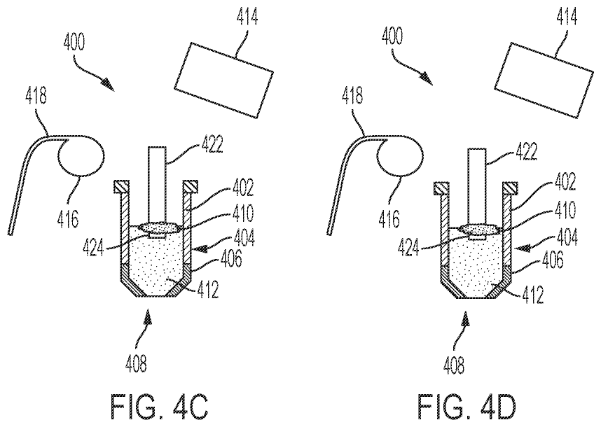

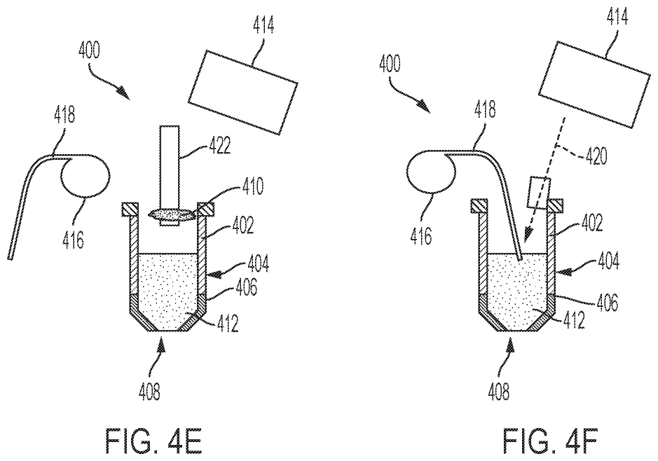

FIGS. 4A-4F are a series of side cross-sectional views of a single liquid ejector jet, illustrating operative steps of using the dross extraction implement, in accordance with the present disclosure. FIG. 4A is a side cross-sectional view of a print head ejector or single liquid ejector jet, similar to the one illustrated in FIG. 1. A liquid ejector jet system 400 is shown, having a printing material supply 416 with a wire feed of printing material 418 shown external to an ejector 402. Certain examples may have the printing material supply 416 located internal to a housing that includes the ejector 402. Furthermore, alternate examples may include other means of introduction of printing material, such as a powder feed system or other printing material introduction means known to those skilled in the art. Example printing materials which could be ejected using a liquid ejector according to examples described herein also include alloys of aluminum, copper, iron, nickel, brasses, naval brass, and bronzes. Silver and alloys thereof, copper and alloys thereof, metallic alloys, braze alloys, or combinations thereof may also be printed using liquid ejectors according to exemplary examples described herein. The ejector jet system 400 of FIG. 4A is shown in open form, allowing access to an inner ejector 402 cavity for the printing material 418 to be introduced therein, where it may be heated to form a molten printing material 412. Other examples of such a system may include additional covers over the ejector jet 402 and said covers having an inlet coupled to the inner cavity that is shown retaining a liquid printing material, but it is shown in this manner for purposes of clarity. The ejector jet system 400 further defines an upper pump area 404, a lower pump area 406, and a nozzle 408 of the liquid ejector jet 402. Within the ejector jet with a dross extraction system 400 is shown a quantity of molten printing material 412. The ejector jet with a dross extraction system 400 also includes an external level sensing system 414, whereby a laser 420 of the level sensing system 414 is directed towards a surface of the melt pool held within the inner cavity of the ejector 402 to measure a level of molten printing material 412 in the ejector jet 402 prior to and during print operations. Also shown is an accumulation of dross 410 inside the inner cavity of the ejector jet 402 on a top surface of the melt pool of molten printing material 412.

FIG. 4B illustrates a cross-sectional schematic of the ejector jet system 400 having an accumulation of dross 410 inside the inner cavity of the ejector jet 402. The introduction of a dross extraction implement 422 into the inner cavity of the ejector jet 402 and removal of the dross 410 may be periodically performed in-situ during the building of a part or other operation of the printing system 400. At a point of sufficient dross 410 accumulation, or at the point of a predetermined service interval, the printer may intermittently pause during to accommodate the dross 410 extraction operation. Prior to the introduction of the dross extraction implement 422 into the ejector 402, a measurement device may perform a baseline measurement of the melt pool or other system parameters, for example to determine a level of molten printing material 412 within the ejector jet 402. In the example shown in FIG. 4B, the printing material supply 416 and the printing material 418 would be removed prior to the introduction of the dross extraction implement 422 into the ejector jet 402. Furthermore, at this point, an inert gas may be introduced near the top portion or upper pump area 404 of the ejector jet 402. As shown in FIG. 4C, the dross extraction implement 422 is lowered to insert the dross extraction implement 422 into the ejector jet 402 where the distal end 424 of the dross extraction implement 422 may be submerged approximately 4-5 mm into the molten printing material 412, although other depths may be used depending on the amount of dross 410 accumulated in the system. Once the dross extraction implement 422 is lowered into the upper pump area 404 as shown, the step 426 of the distal end 424 of the dross extraction implement 422 remains near or at the top of the melt pool of molten printing material 412 as does the accumulated dross 410, due to its density, thereby allowing the dross 410 to adhere to and be drawn onto the step 426 of the dross extraction implement 422. At this time, the dross extraction implement 422 or a portion thereof may or may not be rotating in order to facilitate dross 410 adherence to and extraction. The rotation or movement may enable the dross fragments to be brought into or near the distal end 424 of the dross extraction implement 422. The movement may also maximize surface contact between the distal end 424 of the dross extraction implement 422 and the dross 410. FIG. 4D shows the dross extraction implement 422 still inserted into the molten printing material 412 within the ejector jet 402 while a temperature of the melt pool of molten printing material 412 is reduced from a typical setpoint of approximately 825° C. to a lower temperature of approximately 650° C. In certain examples, the upper, printing temperature may be from about 750° C. to about 825° C., or from about 825° C. to about 900° C., while a lower temperature may be from about 600° C. to about 675° C., or from about 675° C. to about 750° C.

FIG. 4E illustrates the dross extraction implement 422 being removed or extracted from the inner cavity of the ejector jet 402, once the dross 410 is adhered to the dross extraction implement 422. Once the dross extraction implement 422 with the accumulated dross 410 is removed from the inner cavity, the dross 410 is now held within the step 426 of the dross extraction implement 422 as it is retracted back out of the ejector cavity of the ejector jet 402. As the dross 410 is being removed, a gas source, not shown here, may be used to deliver a regulated flow of an inert gas to the environment in or around the dross extraction implement 422 to further cool extracted dross 410 and increase its solidification to prevent further reaction with atmospheric gases as the dross is extracted from the ejector cavity and aid in removal. The gas further may provide a small amount of cooling to the liquid metal held on the dross extraction implement 422 preventing the molten metal from dripping back into the ejector jet 402.

FIG. 4F illustrates a step in the dross extraction showing the dross 410, now removed from the ejector jet 402 after the dross extraction implement 422 is retracted back out of the inner cavity of the ejector jet 402. At this stage, the printing material 418 may be fed back into the inner cavity of the ejector jet 402 the temperature increased back up to the standard printing temperatures, and printing operations or part build can be resumed. Thus, the dross extraction can occur during the part print job and the print job can continue once the dross is removed from the system. At such time, the contaminated probe may be cleaned or disposed of. It should be noted that alternate examples or aspects of a dross extraction implement as described herein to remove accumulated dross. This may include manual introduction and removal of a probe into and out from an ejector jet, such by an operator or by means that is automated. Advantages of using such an in-process dross extraction implement include higher printing throughput, reduced downtime for cleaning or catastrophic failures related to dross accumulation, extended print run time, larger part builds, and increased printing system productivity. Additional system advantages include improved jetting performance, improved measurement, and control of the level of the melt pool inside the ejector jet, enablement of printing system running at higher pump temperatures for improved jet quality, and improved component life, particularly the life of the upper pump of the ejector. Print run time may be greatly expanded before shutdown, which allows for larger size part builds and greater overall productivity. Improved jetting performance may be realized during a print job, including fewer satellite drops developing during the print job as well as a better controlled drop mass. Further improvements include an improvement of the capability of the printing system to measure and control the level of the melt pool height. Additionally, at higher temperatures there is a faster rate of dross build-up which can now be removed, thus enabling running at higher pump temperatures with improved jet quality. Frequent removal of dross also improves the life of the upper pump as dross build up from longer runs can ruin upper pumps.

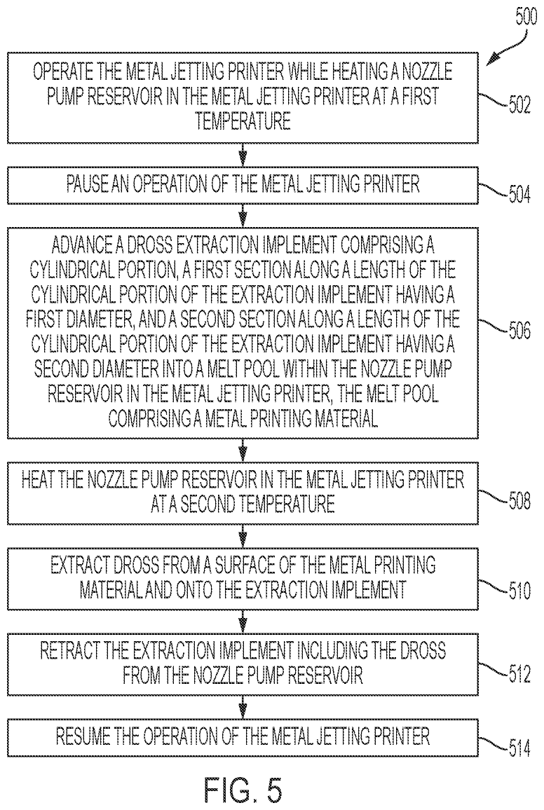

FIG. 5 is a flowchart illustrating a method of extracting dross in a metal jetting printer, in accordance with the present disclosure. A method of extracting dross from a metal jetting printer 500 begins with a step to operate the metal jetting printer while heating a nozzle pump reservoir in the metal jetting printer at a first temperature, followed by a step to pause an operation of the metal jetting printer. The interval to pause the printer in between printing operations may be driven or controlled manually, by a timer, a controller, or by a computer device within the printer, dependent on either one or more sensors within the printer indicating the presence of significant dross contamination on the surface of the melt pool within an ejector jet or a pre-determined interval. In certain examples, this pausing may be executed manually or automatically, either at a pre-determined operation interval or initiated by an external factor, such as a level sensor detecting an interrupted or anomalous reading, an observed printing defect, an inefficient jetting operation, or other atypical reading within the metal jetting printing system. Next, a dross extraction implement having a cylindrical portion, a first section along a length of the cylindrical portion of the extraction implement having a first diameter, and a second section along a length of the cylindrical portion of the extraction implement having a second diameter is advanced into the melt pool within the nozzle pump reservoir in the metal jetting printer, the melt pool comprising a metal printing material 506 and the nozzle pump reservoir is heated at a second temperature 508. Next, dross is extracted from a surface of the metal printing material and onto the extraction implement 510 and then the extraction implement including the dross is retracted from the nozzle pump reservoir 512. The heating to a second temperature may alternately occur prior to retraction of the extraction implement from the nozzle pump reservoir. The first temperature may be greater than the second temperature. For example, the first temperature setpoint may be 825 degrees C. and the second temperature may be 650 degrees C. Finally, the method of extracting dross from a metal jetting printer 500 involves resuming the operation of the metal jetting printer 514.

The method of extracting dross from a metal jetting printer 500 may further include rotating the dross extraction implement while extracting dross from a surface of the metal printing material and onto the extraction implement and while retracting the extraction implement including the dross from the nozzle pump reservoir. This rotation may be accomplished mechanically or manually by an operator. If done mechanically, the rotation speed and/or depth penetration of the extraction implement into the melt pool may be controlled by software or a controller within the printer. In certain examples, the extraction implement or device may reside for a period of time at the surface of the melt pool, or be advanced under the surface of the melt pool for a predetermined length of time in order to absorb a sufficient quantity of dross to prevent detrimental pump and ejector operation. According to certain examples, the method of extracting dross 500 from a metal jetting printer may further include repeating any or all of the steps of the method as previously described or at any specified interval. In certain examples, a loss of laser level sense, which may be referred to as drop out, may indicate a need to extract dross from the ejector jet. Thus, a dross extraction implement may be added to the upper pump, contacting a surface of the melt pool, the melt pool may be cooled down, and the implement removed or retracted from the upper pump. As the implement is retracted, the dross and top portion of the melt pool are also removed, the melt pool may be reheated to the original temperature, and printing may resume.

Certain examples of the method of extracting dross from a metal jetting printer may further include scooping below the surface of the metal printing material with the dross extraction implement to secure dross onto the dross extraction implement. Other examples of the method of extracting dross from a metal jetting printer may further include rotating the dross extraction implement below the surface of the metal printing material to secure dross onto the dross extraction implement, prior to extraction. Alternatively, the method of extracting dross from a metal jetting printer may include wherein the second temperature is such that the metal printing material solidifies in contact with the dross extraction implement while extracting dross from a surface of the metal printing material. In such examples, the second temperature may be at or near a melting temperature of the printing material, whereas the first temperature is well above a melting temperature of the printing material.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A dross extraction implement for a printer, comprising:
a cylindrical portion;
a first section along a length of the cylindrical portion of the extraction implement having a first diameter; and
a second section along a length of the cylindrical portion of the extraction implement having a second diameter; wherein
the first section is adjacent to the second section; and
the extraction implement is configured to be advanced into and retracted from an inner cavity of an ejector in the printer.

2. The dross extraction implement for a printer of claim 1, wherein the second section is adjacent to an end of the cylindrical portion of the extraction implement.

3. The dross extraction implement for a printer of claim 1, wherein the first diameter is greater than the second diameter.

4. The dross extraction implement for a printer of claim 1, wherein the second diameter is greater than the first diameter.

5. The dross extraction implement for a printer of claim 1, wherein the first diameter is the same as the second diameter.

6. The dross extraction implement for a printer of claim 1, wherein the first section of the extraction implement further comprises one or more radial protrusions, wherein each of the one or more radial protrusions comprises a proximal portion and a distal portion, wherein the distal portion protrudes further from a center of the cylindrical portion of the extraction implement as compared to the proximal portion.

7. The dross extraction implement for a printer of claim 1, wherein the first section of the extraction implement further comprises a protrusion that extends from the cylindrical portion at an angle that is less than 90 degrees relative to a longitudinal axis of the cylindrical portion of the extraction implement.

8. The dross extraction implement for a printer of claim 7, wherein the protrusion is continuous.

9. The dross extraction implement for a printer of claim 1, wherein the first section of the extraction implement further comprises a protrusion that extends from the cylindrical portion at an angle that is less than 90 degrees relative to an axis that is perpendicular to a longitudinal axis of the cylindrical portion of the extraction implement.

10. The dross extraction implement for a printer of claim 9, wherein the protrusion is continuous.

11. The dross extraction implement for a printer of claim 1, wherein the first section of the extraction implement further comprises a protrusion, wherein:
the protrusion extends from the cylindrical portion at an angle that is less than 90 degrees relative to a longitudinal axis of the cylindrical portion of the extraction implement; and
the protrusion extends from the cylindrical portion at an angle that is less than 90 degrees relative to an axis that is perpendicular to a longitudinal axis of the cylindrical portion of the extraction implement.

12. The dross extraction implement for a printer of claim 11, wherein the protrusion is continuous.

13. The dross extraction implement for a printer of claim 1, wherein the extraction implement further comprises a ceramic material.

14. The dross extraction implement for a printer of claim 1, wherein the extraction implement is thermally stable at a temperature above 1000° C.

15. The dross extraction implement for a printer of claim 1, wherein the extraction implement is inert in contact with a liquid printing material in the inner cavity of the ejector.

16. The dross extraction implement for a printer of claim 1, wherein the extraction implement comprises tungsten carbide.

17. The dross extraction implement for a printer of claim 1, wherein the second section comprises an upward-facing surface capable of supporting dross as the extraction implement is retracted from the inner cavity of the ejector in the printer.

18. The dross extraction implement for a printer of claim 1, the second section comprises an auger.

19. A dross extraction implement for a metal jetting printer, comprising:
a cylindrical portion; and
a section disposed towards an end of the cylindrical portion of the extraction implement, the section comprising an upward-facing surface; and
wherein the upward-facing surface is capable of supporting dross as the dross extraction implement is retracted from an inner cavity of an ejector in the metal jetting printer.

20. The dross extraction implement for a metal jetting printer of claim 19, wherein the section further comprises a screw, wherein:
the screw comprises one or more threads; and
a surface of the one or more threads comprises the upward-facing surface.

21. The dross extraction implement for a metal jetting printer of claim 19, wherein the section further comprises an auger, wherein:
the auger comprises one or more helical blades; and
a surface of the one or more helical blades comprises the upward-facing surface.

22. The dross extraction implement for a metal jetting printer of claim 19, wherein the section further comprises one or more protrusions extending from the cylindrical portion.

23. The dross extraction implement for a metal jetting printer of claim 22, wherein the one or more protrusions are equally spaced along a length of the cylindrical portion.

24. The dross extraction implement for a metal jetting printer of claim 22, wherein the one or more protrusions are parallel to one another.

25. The dross extraction implement for a metal jetting printer of claim 22, wherein the one or more protrusions are continuous around a circumference of the cylindrical portion.

26. A printer, comprising:
an ejector defining an inner cavity associated therewith, the inner cavity retaining liquid printing material;
a first inlet coupled to the inner cavity; and
a dross extraction implement external to the ejector, comprising:
a cylindrical portion;
a first section along a length of the cylindrical portion of the extraction implement having a first diameter; and
a second section along a length of the cylindrical portion of the extraction implement having a second diameter; wherein
the first section is adjacent to the second section; and
the extraction implement is configured to be advanced into and retracted from the inner cavity of the ejector.

27. The printer of claim 26, wherein:
the second section is adjacent to an end of the cylindrical portion of the extraction implement; and
the first diameter is greater than the second diameter.

28. The printer of claim 26, wherein:
the second section is adjacent to an end of the cylindrical portion of the extraction implement; and
the second diameter is greater than the first diameter.

29. The printer of claim 26, wherein:
the second section is adjacent to an end of the cylindrical portion of the extraction implement; and
the second diameter is equal to the first diameter.

30. The printer of claim 26, wherein the first section of the extraction implement further comprises one or more radial protrusions, wherein each of the one or more radial protrusions comprises a proximal portion and a distal portion, wherein the distal portion protrudes further from a center of the cylindrical portion of the extraction implement as compared to the proximal portion.

31. The printer of claim 26, wherein the first section of the extraction implement further comprises a protrusion, wherein:
the protrusion extends from the cylindrical portion at an angle that is less than 90 degrees relative to a longitudinal axis of the cylindrical portion of the extraction implement; and
the protrusion extends from the cylindrical portion at an angle that is less than 90 degrees relative to an axis that is perpendicular to a longitudinal axis of the cylindrical portion of the extraction implement.

32. The dross extraction implement for a printer of claim 31, wherein the protrusion is continuous.

33. The printer of claim 26, wherein the liquid printing material comprises metal, metallic alloys, or a combination thereof.

34. The printer of claim 26, wherein the liquid printing material comprises aluminum, aluminum alloys, or a combination thereof.

35. A method of extracting dross from a metal jetting printer, comprising:
operating the metal jetting printer while heating a nozzle pump reservoir in the metal jetting printer at a first temperature;
pausing an operation of the metal jetting printer;
advancing a dross extraction implement comprising a cylindrical portion, a first section along a length of the cylindrical portion of the extraction implement having a first diameter, and a second section along a length of the cylindrical portion of the extraction implement having a second diameter into a melt pool within the nozzle pump reservoir in the metal jetting printer, the melt pool comprising a metal printing material;
heating the nozzle pump reservoir in the metal jetting printer at a second temperature;
extracting dross from a surface of the metal printing material and onto the extraction implement;
retracting the extraction implement including the dross from the nozzle pump reservoir; and
resuming the operation of the metal jetting printer.

36. The method of extracting dross from a metal jetting printer of claim 35, further comprising rotating the dross extraction implement while extracting dross from a surface of the metal printing material and onto the extraction implement and while retracting the extraction implement including the dross from the nozzle pump reservoir.

37. The method of extracting dross from a metal jetting printer of claim 35, wherein the first temperature is greater than the second temperature.

38. The method of extracting dross from a metal jetting printer of claim 35, wherein the first temperature is 825 degrees C. and the second temperature is 650 degrees C.

39. The method of extracting dross from a metal jetting printer of claim 35, further comprising scooping below the surface of the metal printing material with the dross extraction implement to secure dross onto the dross extraction implement.

40. The method of extracting dross from a metal jetting printer of claim 35, further comprising rotating the dross extraction implement below the surface of the metal printing material to secure dross onto the dross extraction implement.

41. The method of extracting dross from a metal jetting printer of claim 35, wherein the second temperature is such that the metal printing material solidifies in contact with the dross extraction implement while extracting dross from a surface of the metal printing material.
